(19) United States
(12) Patent Application Publication
(10) Pub. No.: US 2003/0020240 A1
(43) Pub. Date: Jan. 30, 2003

(54) Shaft seal device having shaft seal portions with good sealing and lubrication qualities

(75) Inventor: Shigeru Suzuki, Kariya-shi (JP)

Correspondence Address: WOODCOCK WASHBURN LLP, ONE LIBERTY PLACE, 46TH FLOOR, 1650 MARKET STREET, PHILADELPHIA, PA, 19103, US

(73) Assignee: Kabushiki Kaisha Toyota Jidoshokki

(21) Appl. No.: 10/205,170

(22) Filed: Jul. 25, 2002

(30) Foreign Application Priority Data
Jul. 30, 2001 (JP) 2001-229323
Jan. 15, 2002 (JP) 2002-006662

(51) Int. Cl. F16J 15/34

(52) U.S. Cl. 277/361

(57) ABSTRACT

The shaft seal device of the present invention seals the periphery of a rotating shaft of a fluidic machine that comprises a casing 2 including a mechanism compartment 50 having a compressing or pumping mechanism portion 51 which compresses or pumps an actuating fluid, and a rotating shaft 3, one end of which extends from the casing 2 to an outside and the other end of which is inserted into the mechanism compartment 50 and is connected to the compressing or pumping mechanism portion 51. The shaft seal device has an oil chamber 8 which is provided, within the casing 2 and adjacent to the mechanism compartment 50 in which oil is hermetically contained, a first shaft seal portion 9 arranged between the oil chamber 8 and the mechanism compartment 50, and a second shaft seal portion 7 arranged between the oil chamber 8 and the outside.

### BACKGROUND OF THE INVENTION

1. Field of the Invention

The present invention relates to a shaft seal device for a fluidic machine, for example, a pump shaft seal device which seals a periphery of a rotating shaft of a machine such as a pump.

2. Description of the Related Art

In some fluidic machines, such as a pump, a compressor, a blower, etc., a rotating shaft is driven by an external driving force so as to compress an actuating fluid. In such a type of a fluidic machine, a mechanism compartment, having a compressing or pumping mechanism portion which compresses or pumps an actuating fluid, is formed in a casing. One end of the rotating shaft extends outside the casing and the other end the rotating shaft is coupled to the compressing or pumping mechanism portion.

In such a fluidic machine, it is possible for an actuating fluid in the mechanism compartment to leak out to an outside through a periphery of the rotating shaft due to the pressure difference between the mechanism compartment and the outside. Therefore, in order to prevent the leakage, a shaft seal device is disposed on the periphery of the rotating shaft.

As an example, a swash plate type compressor, which is disclosed in Japanese patent publication No. 61-123779, is shown in FIG. 9. As shown in the figure, a compressor 100 comprises a casing 101, a rotating shaft 102, an oil chamber 103, a seal ring 104, and a mechanical seal 105. The casing 101 forms an outer shell of the compressor 100 and is provided with a mechanism compartment 106 inside. A compressing or pumping mechanism portion 110, which comprises pistons 107, a swash plate 108, cylinder bores 109, etc. is disposed in the mechanism compartment 106. The oil chamber 103 is disposed in an adjacent position in front of the mechanism chamber 106. The rotating shaft 102 which penetrates the oil chamber 103 so as to communicate the compressing or pumping mechanism portion 110 to the outside 113 is provided. A communicating hole 111 and a check valve 112 are disposed in an upper portion of a partition wall between the oil chamber 103 and the mechanism compartment 106. Accordingly, the oil can only flow in the direction from the oil chamber 103 side to the mechanism compartment 106 side. The seal ring 104 is disposed on the periphery of the rotating shaft 102 and on the partition wall between the oil chamber 103 and the mechanism compartment 106. The mechanical seal 105 is disposed on the periphery of the rotating shaft 102 and in a partition wall between the oil chamber 103 and the outside 113.

On the other hand, the larger the pressure difference between the mechanism compartment 106 and the outside 113, the easier it is for the actuating fluid to leak out to the outside. Thus, the oil chamber 103 is provided in the compressor 100, as a pressure regulating chamber. That is, when the actuating fluid flows through the seal ring 104 into the oil chamber 103 from the mechanism compartment 106, the pressure in the oil chamber 103 increases. When the inside pressure in the oil chamber 103 becomes higher than that in the mechanism compartment 106 and then the pressure difference between the oil chamber 103 and the mechanism compartment 106 becomes larger than a predetermined pressure, the check valve 112 opens and the actuating fluid is discharged from the oil chamber 103 to the mechanism chamber 106. As mentioned above, the inside pressure in the oil chamber 103 is maintained so that it does not exceed the predetermined pressure. Thus, the leakage of the actuating fluid to the outside 113 is prevented.

In the shaft seal device of the conventional compressor 100 described above, the pressure difference between the oil chamber 103 and the mechanism compartment 106 is always maintained below the predetermined pressure by the check valve 112. Accordingly, the oil chamber 103 is open to the mechanism compartment 106 side by the check valve 112. Thus, when the inside pressure in the oil chamber 103 increases, oil flows through the check valve 112 into the mechanism compartment 106. That is, the oil does not flow through the seal ring 104 into the mechanism compartment 106. Therefore, in a shaft seal of a conventional fluidic machine, the oil in the oil chamber 103 is used only for regulating pressure between the oil chamber 103 and the mechanism compartment 106 and it cannot be said that the sealing and the lubrication qualities which the oil has are sufficiently utilized. Also, according to the conventional shaft seal, it is necessary that the communicating hole 111 to the check valve 112 is provided, in order to communicate the oil chamber 103 and the mechanism compartment 106. Therefore, the structure of the shaft seal device is complicated and, in particular, a shaft seal device such as the conventional one is difficult to be combined in a small compressor.

### SUMMARY OF THE INVENTION

A shaft seal device of the present invention has been developed with above-mentioned problems being taken into consideration and the purpose of the present invention is to provide a shaft seal device the structure of which is simple and which has an oil chamber able to supply oil to its shaft seal portions.

(1) To realize the above-mentioned purpose, the shaft seal device of the present invention seals the periphery of a rotating shaft of a fluidic machine that comprises a casing, inside which a mechanism compartment having a compressing or pumping mechanism portion which compresses or pumps an actuating fluid is provided, and the rotating shaft, one end of which extends from the casing to an outside and the other end of which is inserted into the mechanism compartment, and is connected to the compressing or pumping mechanism portion. The shaft seal device of the present invention is characterized in that it has an oil chamber that is provided within the casing and adjacent to the mechanism compartment, through which the rotating shaft penetrates and in which oil is hermetically contained, so that the oil chamber and the mechanism compartment are arranged side by side, a first shaft seal portion arranged between the oil chamber and the mechanism compartment, and a second shaft seal portion arranged between the oil chamber and the outside.

In the shaft seal device of the present invention, the oil chamber is provided within the casing and adjacent to the mechanism compartment so that the oil chamber and the mechanism compartment are arranged side by side, the first shaft seal portion is arranged between the oil chamber and the mechanism compartment, and the second shaft seal portion is arranged between the oil chamber and the outside, respectively. The oil chamber is formed as a hermetically sealed structure filled with oil.

According to the shaft seal device of the present invention, only a very small clearance, which is formed in the first shaft seal portion, communicates the oil chamber to the mechanism compartment. That is, different from the shaft seal device of the conventional compressor 100 mentioned above, the communicating hole 111 and the check valve 112 are not provided. Accordingly, the pressure in the oil chamber is not regulated and the inside pressure in the oil chamber varies. Therefore, when the inside pressure in the mechanism compartment is higher than that in the oil chamber, the actuating fluid is introduced into the oil chamber. On the other hand, oil is filled in the oil chamber. Moreover, if the actuating fluid passes through the oil chamber, the second shaft seal portion is provided on the outflow side of the oil chamber, so that it is less possible that the actuating fluid leaks out to the outside. However, when the inside pressure in the oil chamber is higher than that in the mechanism compartment, the oil is introduced into the mechanism compartment from the oil chamber. In this case, oil passes through a very small clearance provided in the first shaft seal portion. By passing through the very small clearance, the oil is supplied into a sliding contact portion formed between a rotating portion of the first shaft seal portion and a fixed portion thereof. By the oil supplied, it is possible to improve the lubrication and the sealing qualities of the sliding contact portion. In particular, just after a fluidic machine is started to be operated, in the shaft seal device used for the conventional compressor 100 described above, a lack of oil films on the sliding contact portions is likely to occur. Therefore, the sealing quality thereof is likely to be degraded. However, according to the shaft seal device of the present invention, the oil can always be supplied from the oil chamber to the sliding contact portions by the pressure difference between the oil chamber and the mechanism compartment during both the operation condition of the fluidic machine and the stopped condition thereof. As a result, independent of the operation condition of a machine, a good sealing quality can be maintained. Further, as the oil is a liquid, it is possible to decrease the inside pressure in the oil chamber by passing only a small amount of the oil. Therefore, the amount of the oil flowing out from the oil chamber to the mechanism compartment is very small. As a result, the oil flowing into the mechanism compartment has only a little influence on the actuating fluid.

(2) Preferably, the second shaft seal portion of the shaft seal device is formed by a mechanical seal. The mechanical seal has a structure such that a rotating surface and a fixed surface thereof, which are both completed in high accuracy and are arranged orthogonally to the axis, are in contact so that sliding is possible and, thereby, the fluid which should be hermetically sealed is prevented from leaking. The mechanical seal, in comparison with other sealing devices, such as a gland packing, etc., causes a small amount of leakage of the fluid which should be hermetically sealed. Therefore, in case that the mechanical seal is used as the second shaft seal portion, even if the actuating fluid passes through the first shaft seal portion and the oil chamber, the actuating fluid can be surely restricted from leaking out to the outside.

(3) Preferably, the first shaft seal portion of the shaft seal device is formed by a mechanical seal. The mechanical seal has a high sealing quality to prevent fluid from flowing from a high pressure side to a low pressure side, but, on the contrary, it has a low sealing quality to prevent the fluid from flowing from the low pressure side to the high pressure side. Therefore, when the mechanical seal is disposed so that the mechanism compartment side is in the high pressure side and the oil chamber side is in the low pressure side, the fluid is allowed to flow only in the direction from the oil chamber side to the mechanism compartment side. As a result, when the pressure in the mechanism compartment is higher than that of the oil chamber, the flow of the actuating fluid from the mechanism compartment to the oil chamber can be effectively restricted. On the contrary, when the pressure in the oil chamber is higher than that of the mechanism compartment, the flow of the oil from the oil chamber to the mechanism compartment can be permitted as long as the pressure difference therebetween exists. This makes the oil supplied contact the surfaces more easily and the lubrication and sealing qualities of the sliding contact surfaces can be improved.

(4) Preferably, at least either of the first shaft seal portion or the second shaft seal portion of the shaft seal device is formed by a lip seal which has a resilient lip contacting the rotating shaft so that sliding is possible. The lip seal is arranged on an inner circumferential surface of a through hole. The rotating shaft is arranged in the center of the inner circumferential side of the through-hole. The resilient lip contacts the outer circumferential surface of the rotating shaft so that sliding is possible. The lip seal has fewer parts than the mechanical seal. Therefore, according to this construction, the structure of the shaft seal device can be simplified. Moreover, the lip seal is more compact than the mechanical seal. As a result, according to the present construction, the shaft seal device can be miniaturized.

(5) Also, the surface of the resilient lip is preferably formed by a resin. The resin has higher durability against materials such as dimethyl ether (DME), etc., than a rubber. That is, the resin is more difficult to be degraded than the rubber. Therefore, according to the present construction, when the fluid which should be sealed is DME, or the like, the life of the resilient lip can be extended.

(6) Preferably, in the construction of the item (5) described above, the resin is made of a fluoric resin. The fluoric resin has a relatively low friction coefficient. Therefore, if the surface of the resilient lips is formed by the fluoric resin, the friction coefficient of the sliding surface between the rotating shaft and the resilient lips is made lower. The fluoric resin has particularly higher chemical resistance than a rubber, other resins, etc. As a result, when the surface of the resilient lips is formed by the fluoric resin, the life of the resilient lip can be extended.

(7) Preferably, the lip seal has two resilient lips and the two resilient lips are constructed so as to be bent in two directions separated apart each other and so as to contact the rotating shaft so that sliding is possible. The resilient lips, at first, extend from the inner circumferential surface of the through hole toward the outer circumferential surface of the rotating shaft, that is, in the direction in which the diameter is reduced, and, at next, extend along the outer circumferential surface of the rotating shaft while being bent. In the present construction of the lip seal two resilient lips are provided. In addition, the two resilient lips are arranged so as to be bent in two directions separating apart each other. The resilient lips have different sealing qualities with respect to flow direction of the fluid which is sealed. Therefore, when the two resilient lips are arranged so as to be bent in two directions separating apart each other, a good sealing quality in two opposite directions can be obtained.

(8) Also, preferably, the lip seal has a construction in which an o-ring arranged on the inner circumferential surface of the through hole through which the rotating shaft penetrates, and a torque isolating member, which is interposed between the o-ring and the resilient lip and restricts the o-ring from rotating together with the resilient lip when the resilient lip is rotated by friction resistance created between the rotating shaft and the sliding contact surface, are provided. The rotating shaft is arranged in the inner circumferential side of the resilient lip. On the other hand, the o-ring is arranged on the outer circumferential side of the resilient lip. The o-ring is fixed on the inner circumferential surface of the through hole. Therefore, when the rotating shaft rotates, the resilient lip may be also rotated in some cases. When the resilient lip is rotated, the inner circumferential surface of the o-ring is made to be rotated, however, as the outer circumferential surface of the o-ring is fixed in the through hole, a shear force is actuated on the o-ring. The shear force often causes damage to the o-ring. On the other hand, the shaft seal device of the present construction is provided with a torque isolating member. That is, the torque isolating member prevents the o-ring from rotating and receives the shear force. Therefore, according to the present construction, the shear force acting on the o-ring is restricted. As a result, damage, to the o-ring, causing problems, such as the degradation of a sealing quality, can be prevented.

(9) Also, more preferably, the shaft seal device of the present invention is constructed to be applied to a piston type pump. The piston type pump makes the rotating force of a rotating shaft converted to a reciprocating force of pistons to compress an actuating fluid. The suction pressure of a pump changes less than that of a compressor, etc. Accordingly, the inner pressure change in a mechanism compartment of the pump is small. Therefore, if the shaft seal device of the present invention is applied to the piston type pump and, at the same time, the inner pressure in the oil chamber of the shaft seal device is set to be approximately equal to that in the mechanism compartment thereof, the pressure difference between the oil chamber and the mechanism compartment can be reduced. As a result, the leakage of the actuating fluid from the mechanism compartment to the oil chamber can be more effectively restricted.

(10) Also, the shaft seal device of the present construction is especially preferable to be applied to a piston type pump which uses an actuating fluid such as DME, propane, or the like.

Recently, DME, propane, or the like, the exhaust gas of which is clean, is being used as an alternative fuel to the light oil currently used for diesel driven vehicles, such as trucks. A fuel supply system which uses, for example, DME as fuel comprises a fuel tank, a supply pump, a main pump, and an injector in that order from the upstream side. In this system, DME has a boiling point at −24 Celsius degree, so that it is a gas at atmospheric temperature and pressure. Therefore, DME is pressurized, liquefied, and stored in a fuel tank in a state of liquid. The liquefied DME is pumped to the main pump by the supply pump.

However, in the supply pump, the leakage of DME from the mechanism compartment to the outside is one of problems to be solved. In order to prevent the leakage, sealing oil may be mixed into DME. On the other hand, DME is used as fuel, so that if the amount of the mixed sealing oil is too much, it is possible that incomplete combustion of the fuel occurs and the exhaust gas of the fuel becomes dirty. Accordingly, an increased amount of the mixed sealing oil should be prevented. In addition, DME has cleaning function for oil. As a result, an oil film provided in the shaft seal device is also cleaned and the amount of the oil is reduced. For the reasons mentioned above, in a conventional shaft seal device of a pump it has been possible that DME leaks out from the mechanism compartment to the outside.

On the contrary, according to the shaft seal device of the present construction, oil for the first shaft seal portion can be supplied from the oil chamber without oil being mixed into the actuating fluid, such as the DME, propane, or the like. Further, even if DME or the like removes the oil, the oil can be continuously supplied from the oil chamber to the first shaft seal portion. Moreover, if DME, or the like, flows out from the first shaft seal portion, it does not leak out to the outside as long as it does not pass through the oil chamber and the second shaft seal portion. Therefore, it is less possible that DME, or the like, leaks to the outside. Thus, the shaft seal device of the present construction is especially preferable to be used for a piston type pump which uses DME, propane, or the like as the actuating fluid.

The present invention may be more fully understood from the description of the preferred embodiments of the invention set forth below, together with the accompanying drawings.

### BRIEF DESCRIPTION OF THE DRAWINGS

In the drawings:

FIG. 1 is an axial sectional view of a pump comprising a shaft seal device of the first embodiment of the present invention.

FIG. 2 is a view showing the principal of the pump shown in FIG. 1.

FIG. 3 is an enlarged view of a first shaft seal portion of the shaft seal device of the first embodiment of the present invention.

FIG. 4 is an axial sectional view of a pump comprising a shaft seal device of the second embodiment of the present invention.

FIG. 5 is an enlarged view of a first shaft seal portion of the shaft seal device of the second embodiment of the present invention.

FIG. 6 is an axial sectional view of a pump comprising a shaft seal device of the third embodiment of the present invention.

FIG. 7 is an enlarged view of a first shaft seal portion of the shaft seal device of the third embodiment of the present invention.

FIG. 8 is an enlarged view of a second shaft seal portion of the shaft seal device of the third embodiment of the present invention.

FIG. 9 is an axial sectional view of a compressor comprising a conventional shaft seal device.

### DESCRIPTION OF THE PREFERRED EMBODIMENTS

The embodiments of a shaft seal device of the present invention are described below. The shaft seal device of the present embodiments is used for a swash plate pump of an axial piston type which is a supply pump for DME.

(First Embodiment)

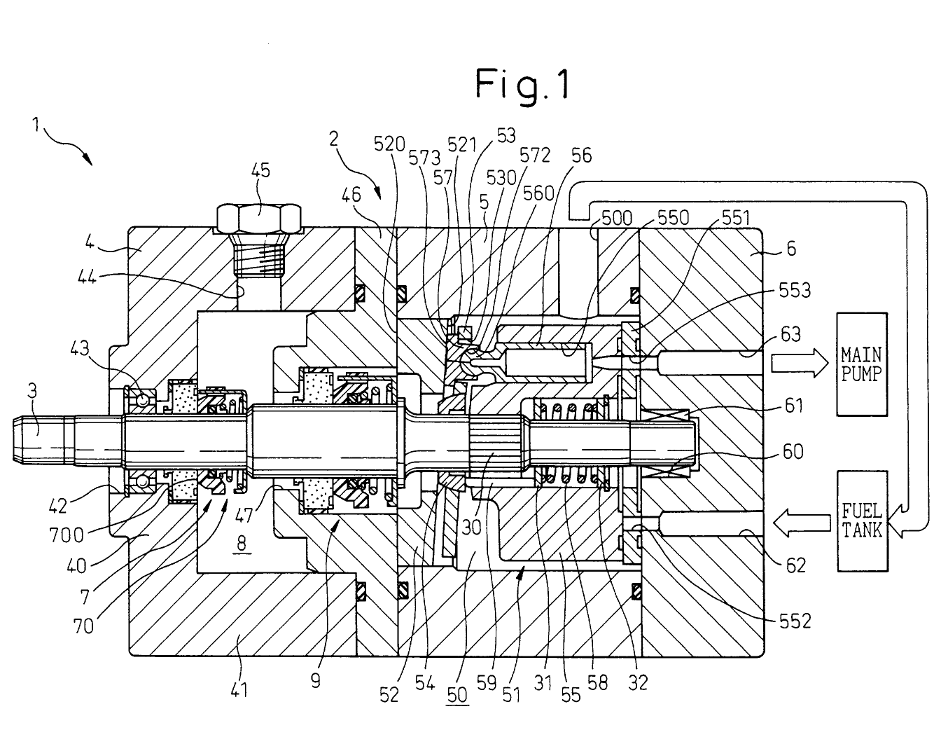

(1) The first embodiment of the shaft seal device of the present invention is now described. At first, the construction of a pump which comprises the shaft seal device of the present embodiment is described. An axial sectional view of this pump is shown in FIG. 1. As shown in the figure, a pump 1 comprises a casing 2 and a rotating shaft 3. The casing 2 comprises a front housing 4, a partition wall 46, a cylinder housing 5, and a rear housing 6.

The front housing 4 is composed of a disc-shaped end plate 40 and a side circumferential wall 41 having a tubular shape and extending in the rear direction from a circumferential edge of the end plate 40. That is, the front housing 4 has a cup-shaped opening directed to the rear side. In the center of the end plate 40, a through hole 42 which runs in a direction from the front to the rear is provided. In the front portion of an inner circumferential surface of the through hole 42, a bearing 43 is disposed. Also, in the rear portion of the inner circumferential surface of the through hole 42, a second shaft seal portion 7 which constitutes the shaft seal device is disposed. The second shaft seal portion 7 is described later. In the more inner circumferential side of the bearing 43 and the second shaft seal portion 7 in the through hole 42, a front portion of the rotating shaft 3 is inserted into and supported. An oil filling port 44 through which oil is filled penetrates through an upper portion of the side circumferential wall 41. An oil filling plug 45 is attached to the oil filling port 44 by a thread.

At the rear of the side circumferential wall 41, the disk-shaped partition wall 46 is disposed so as to close an opening in the front housing 4. An oil chamber 8 which constitutes the shaft seal device is formed by being surrounded by the front housing 4 and the partition wall 46. The oil chamber 8 is described later. In the center of the partition wall 46, a through hole 47 which passes in a direction from the front to the rear is provided. In the inner circumferential side of the through hole 47, a first shaft seal portion 9 which constitutes the shaft seal device is disposed. The first shaft seal portion 9 is described later. In the more inner circumferential side of the first shaft seal portion 9, an intermediate portion of the rotating shaft 3 is interposed.

In the rear side of the partition wall 46, the cylinder housing 5 is disposed. The cylinder housing 5 has a cylindrical shape extending in a direction from the front to the rear. A mechanism chamber 50 is formed within the cylinder housing 5. A compressing or pumping mechanism portion 51 which compresses and pumps DME is arranged in the mechanism chamber 50. The compressing or pumping mechanism portion 51 comprises a fixed swash plate 52, a slipper retainer 53, a pivot 54, a cylinder block 55, pistons 56, slippers 57, a coil spring 58, and a bush pin 59. The fixed swash plate 52 has a thick disc shape which has a front end surface 520, which is a circular surface perpendicular to the rotating shaft 3, and a rear end surface 521, which is an elliptical surface inclined against the rotating shaft 3. The rotating shaft 3 passes through a central through hole in the fixed swash plate 52 in a direction from the front to the rear. On an outer circumferential surface of the rotating shaft 3 which is positioned in a more rear position than that of the rear end surface 521, the pivot 54 which has an outer circumferential surface with a spherical shape is inserted so as to surround the rotating shaft 3. Also, on an outer circumferential surface of the rotating shaft 3 which is positioned in a more rear position than that of the pivot 54, a spline 30 is provided. The lotus-root shaped cylinder block 55 is inserted into an outer circumferential side of the spline 30 so that it can rotate together with the rotating shaft 3. On an outer circumferential surface of the rotating shaft 3 which is positioned in a more rear position than that of the spline 30, a collar-shaped front spacer 31 and a rear spacer 32 with the same shape as the front spacer 31, which are spaced apart each other is inserted so as to surround the rotating shaft 3. A coil spring 58 are interposed between the front spacer 31 and the rear spacer 32. A rod-shaped bush pin 59 is interposed between the front spacer 31 and the pivot 54. That is, the pivot 54 is biased forward by the coil spring 58 through the front spacer 31 and the bush pin 59. On the other hand, on an outer circumferential surface of the pivot 54, the disc-shaped slipper retainer 53 is inserted so as to surround the pivot 54 so that swinging is possible. On an outer circumferential portion of the slipper retainer 53, a plurality of insertion holes 530 are provided with a same interval in a specific angle. Slippers 57 are inserted into the insertion holes 530 from the front. An opening portion 572 which opens backward and has a inner circumferential surface having a reverse spherical shape is provided on a rear end surface of the slipper 57. On the other hand, a front end surface 573 of the slipper 57 comes into contact with the rear end surface 521 of the fixed swash plate 52. Cylinder bores 550 which open forward are arranged in an outer circumference of the cylinder block 55 with a same interval in a specific angle. The pistons 56 are inserted into the cylinder bores 550. An end portion 560 of each piston 56 has a spherical shape. The front end portions 560, with spherical shapes, of the pistons 56 are coupled into the opening portions 572 of the slippers 57 so as to be able to move. A port plate 551 is disposed in a rear side of the cylinder block 55. The port plate 551 has a disc shape. In the port plate 551, an almost half-circle shaped suction port 552 and a similarly almost half-circle shaped discharge port 553 are provided so that they penetrate through the port plate 551 in a direction from the front to the rear. In an upper portion in a side circumferential wall of the cylinder housing 5, a drain port 500 which is connected to a fuel tank is provided so that it penetrates through the cylinder housing 5 in a vertical direction (a direction from the top to the bottom).

The rear housing 6 is disposed in a rear side of the cylinder housing 5. The rear housing 6 has a disc shape. A cup-shaped bearing portion 60 which has an opening in its front portion is provided on the front end surface of the rear housing 6. A bearing 61 is disposed in an inner circumferential side of the bearing portion 60. The rear end of the rotation shaft 3 is inserted at a more inner circumferential side than the bearing 61 and is supported by the bearing 61. A suction passage 62 and a discharge passage 63 which pass through in a direction from the front to the rear are provided in the rear housing 6, respectively. The front end of the suction passage 62 is connected to the suction port 552. The rear end of the suction passage 62 is connected to the fuel tank. The front end of the discharge passage 63 is connected to the discharge port 553. The rear end of the discharge passage 63 is connected to a main pump which pumps fuel to an injector.

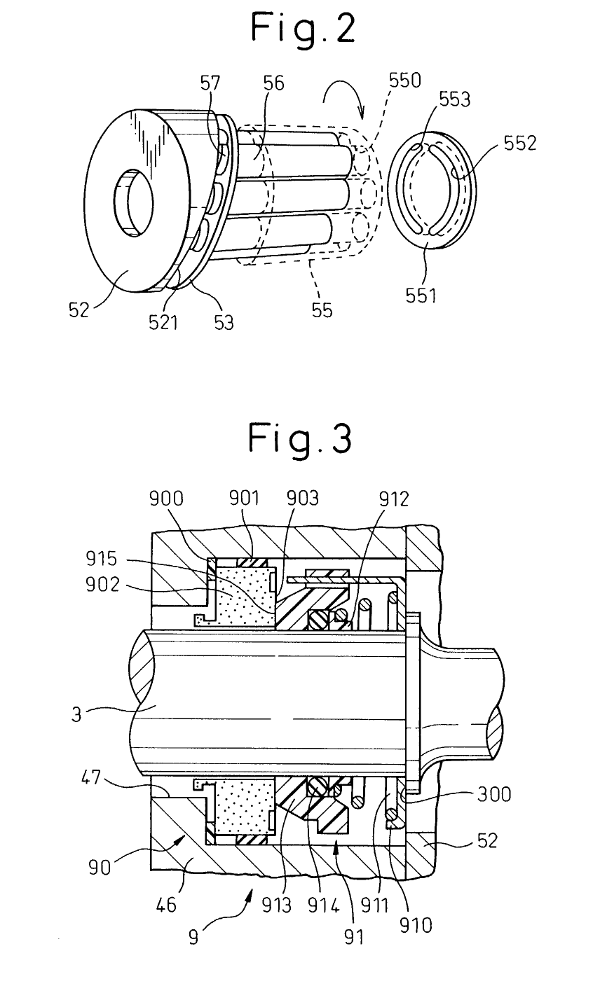

(2) The movement of the pump which comprises the shaft seal device of the present embodiment will be described. FIG. 2 is the figure which shows the principle of the pump shown in FIG. 1. The members, in FIG. 2, corresponding to FIG. 1 are denoted by the same reference characters and numbers in FIG. 1. Members which are static in the figure are the fixed swash plate 52 and the port plate 551. Other members are rotated in the direction indicated by an arrow in the figure by a rotation force of the rotating shaft 3 transferred through the spline 30. In this case, the rear end surface 521 of the fixed swash plate 52 is inclined against the rotating shaft 3. The slippers 57 rotate while they slide on the rear end surface 521. Therefore, the pistons 56 connected to the slippers 57 rotate so that they draw elliptical lines in a direction inclining against axial line from the front to the rear. Due to the reciprocating motion of the pistons 56 in a direction from the front to the rear, DME is sucked and compressed in the cylinder bores 550 formed in the cylinder block 55.

DME is sucked, while the pistons 56 rotate and pass the near side in the figure. In that case, the pistons 56 move from the right side to the left side in the figure. DME is then drawn from the fuel tank through the suction port 552 formed in the port plate 551.

On the other hand, DME is discharged while the pistons 56 rotate and pass the far side in the figure. In that case, the pistons 56 move from the left side to the right side in the figure. DME is then discharged to the main pump through the discharge port 553 formed in the port plate 551. Thus as described above, the pump draws and discharges DME.

(3) The construction of the shaft seal device of the present embodiment will be described. The shaft seal device of the present embodiment comprises the first shaft seal portion 9, the oil chamber 8, and the second shaft seal portion 7, shown in FIG. 1.

The first shaft seal portion 9 will be described. FIG. 3 shows an enlarged view of the first shaft seal portion 9. The members, in FIG. 3, corresponding to FIG. 1 are denoted by the same reference characters and numbers in FIG. 1. As shown in the figure, the first shaft seal portion 9 is a mechanical seal. The first shaft seal portion 9 comprises a fixed side member 90 and a rotating side member 91.

The fixed side member 90 comprises a seal ring 900, a rubber ring 901, and a seat ring 902. The seal ring 900 is attached to a stepped portion from a small diameter side to a large diameter side, in the through hole 47 of the partition wall 46. The rubber ring 901 is attached to an inner circumferential surface of a large diameter side in the through hole 47 of the partition wall 46. The seat ring 902 is fixed by inserting into the inner circumferential side of the rubber ring 901 and in the rear side of the seal ring 900. The rear end surface of the seat ring 902 is formed as a fixed surface 903 which contacts the rotating side member 91 so that sliding is possible.

On the other hand, the rotating side member 91 comprises a spring holder 910, a coil spring 911, a shaft packing 912, a sliding ring 913, and a rubber ring 914. The spring holder 910 has a shape like a collar and is fixed so that it comes into contact with a step portion 300 of the rotating shaft 3. A mechanical seal disposed in the first shaft seal portion 9 has a diameter larger than that of a mechanical seal disposed in the second shaft seal portion 7, because the mechanical seal in the first shaft seal portion 9 is positioned on the rotating shaft 3 after it passes over a step portion supporting a spring holder of the second shaft seal portion 7. In front of the spring holder 910, the coil spring 911 is arranged so as to be inserted on and surround the rotating shaft 3. Also in front of the coil spring 911, the collar-shaped rubber shaft packing 912 is arranged so as to be inserted on and surround the rotating shaft 3. Moreover in front of the shaft packing 912, the sliding ring 913 is arranged via the rubber ring 914 so as to be inserted on and surround the rotating shaft 3. The front end surface of the sliding ring 913 is provided with a sliding surface 915 which contacts the fixed surface 903 so that sliding is possible.

The second shaft seal portion 7 is a mechanical seal which is same as the first shaft seal portion 9. Therefore, an explanation of the construction of the second shaft seal portion 7 is omitted.

The oil chamber 8 will be described. As shown in FIG. 1, the oil chamber 8 is provided between the first shaft seal portion 9 and the second shaft seal portion 7. The oil chamber 8 is filled with oil through the oil filling port 44. The oil chamber 8 is hermetically closed by the oil filling plug 45.

(4) The function of the shaft seal device of the present embodiment is then described. At first, the case in which the inner pressure in the mechanism compartment 50 shown in FIG. 1 is higher than that in the oil chamber 8 is described. In this case, DME reaches the sliding contact portion between the sliding surface 915 and the fixed surface 903, after passing through the outer circumferential side of the spring holder 910 shown in FIG. 3. DME then passes through a small clearance in the sliding contact portion and then passes through a clearance between the seat ring 902 and the rotating shaft 3 so as to reach the oil chamber 8. However, the oil chamber 8 shown in FIG. 1 is filled with oil and hermetically closed. The second shaft seal portion 7 is arranged in front of the oil chamber 8. Moreover, as shown in FIG. 1, a rotating side member 70 of the second shaft seal portion 7 is disposed within the oil chamber 8. Accordingly, a sliding surface 700 is always supplied with oil in the oil chamber 8. Therefore, the sealing and lubrication qualities of the sliding surface 700 are kept in a good condition. For these reasons, there is little possibility for DME to pass through both the oil chamber 8 and the second shaft seal portion 7. As a result, it is less possible for DME to leak out to the outside.

The case in which the inner pressure in the oil chamber 8 shown in FIG. 1 is higher than that in the mechanism compartment 50 will be described. In this case, oil reaches the sliding contact portion between the sliding surface 915 and the fixed surface 903, after passing through the clearance between the seat ring 902 and the rotating shaft 3 shown in FIG. 3. The oil then passes through a small clearance between the sliding surface 915 and the fixed surface 903. Thus, oil is supplied to the sliding contact portion. The sealing and lubrication qualities of the sliding contact portion are improved by the oil. The oil passing through the sliding contact portion passes through the outer circumferential side of the spring holder 910 and flows into the mechanism compartment 50 shown in FIG. 1.

Then, the oil flowing into the mechanism compartment 50 is recovered from the drain port 500 and flows into the fuel tank. Accordingly, it is less possible for the oil to be supplied to the main pump directly though the discharge passage 63 together with the fuel DME. Therefore, it is possible to prevent the oil density in the fuel DME from being raised suddenly and rapidly. Due to the temperature change, the pressure in the oil chamber 8 is varied and, in the case of a liquid such as DME, the pressure in the mechanism compartment 50 side is also varied due to the temperature change, similarly. As a result, the pressure in the oil chamber 8 side never raises considerably higher than that in the mechanism compartment 50 side.

(Second Embodiment)

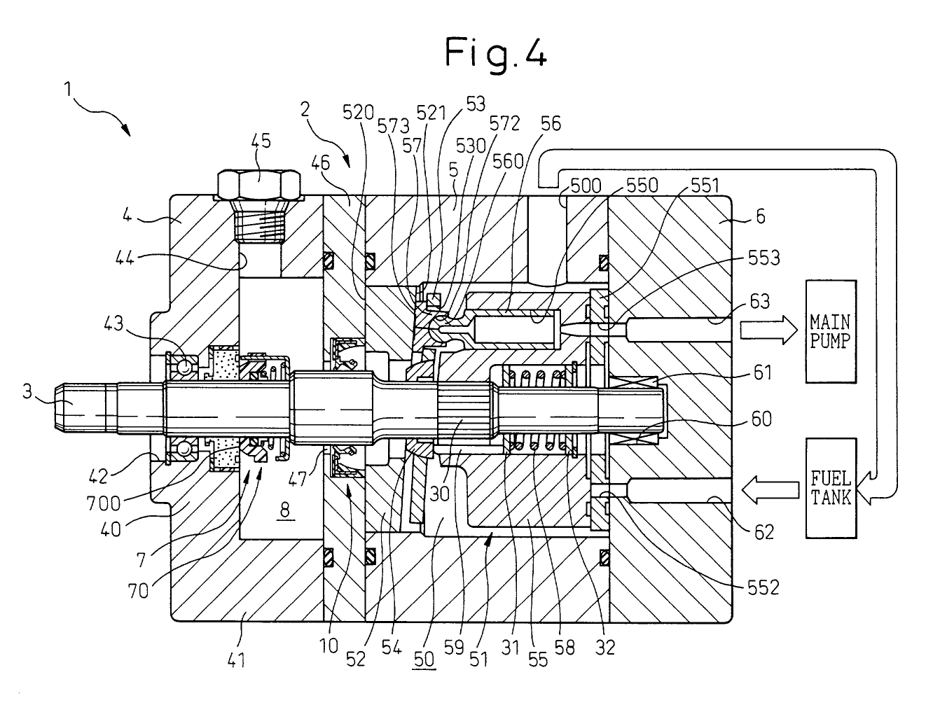

(1) The second embodiment of the shaft seal device of the present invention will be described. The construction of a pump which comprises a shaft seal device of the present embodiment is similar as the first embodiment, as shown in FIG. 4. The members, in FIG. 4, corresponding to the members in FIG. 1 are denoted with the same reference characters and numbers in FIG. 1. The different point of the present embodiment from the first embodiment is that a first shaft seal portion 10 of the shaft seal device is made of an oil seal. As the first shaft seal portion 10 is made of an oil seal, the length of the pump 1 in a direction from the front to the rear can be shortened. Therefore, according to the present embodiment the pump 1 can be miniaturized.

(2) The construction of the shaft seal device of the present embodiment is now described. The shaft seal device of the present embodiment comprises a first shaft seal portion 10, an oil chamber 8, and a second shaft seal portion 7 in FIG. 4.

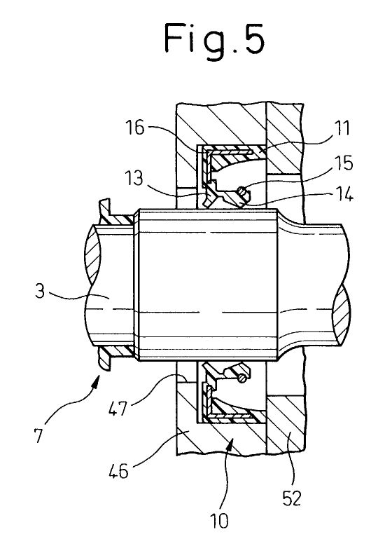

The difference between the present embodiment and the first embodiment is the first shaft seal portion 10. FIG. 5 shows an enlarged view of the first shaft seal portion. The members, in FIG. 5, corresponding to the members in FIG. 4 are denoted with the same reference characters and numbers in FIG. 4. As shown in the figure, the first shaft seal portion 10 is an oil seal. The first oil seal portion 10 has a shape having double cylinders which open backward. In the outer circumferential cylinder side of the first shaft seal portion 10, a cylindrical inserting portion 11 which is inserted into the inner circumferential surface of the through hole 47 in the partition wall portion 46, is arranged. A dust lip 13 which resiliently contacts the rotating shaft 3 is arranged in the front portion of the inner circumferential cylinder side of the first shaft seal portion 10. A main lip 14, which has a wedge-shaped cross-section and resiliently contacts the rotating shaft 3, is arranged in the rear portion of the inner circumferential cylinder side of the first shaft seal portion 10. A ring spring 15 which biases and tightens the main lip 14 toward the rotating shaft 3 is inserted at the back surface of the main lip 14 opposite to the rotating shaft 3 so that it surrounds the rotating shaft 3. A metallic ring 16 is integrally installed inside the first shaft seal portion 10 so that it is embedded therein.

(3) The function of the shaft seal device of the present embodiment will be described. At first, the case in which the inner pressure in the mechanism compartment 50 shown in FIG. 4 is higher than that in the oil chamber 8 is described. In this case, DME flows into the oil chamber 8 through the clearance in the inner circumferential side of the main lip 14 and the dust lip 13 shown in FIG. 5. However, the oil chamber 8 shown in FIG. 4 is filled with oil and hermetically sealed. The second shaft seal portion 7 is arranged in front of the oil chamber 8. Moreover, as shown in FIG. 4, the rotating side member 70 of the second shaft seal portion 7 is disposed within the oil chamber 8. Accordingly, the sliding surface 700 is always supplied with oil in the oil chamber 8. Therefore, the sealing and lubrication qualities of the sliding surface 700 are maintained in a good condition. From these reasons, there is little possibility for DME to pass through both the oil chamber 8 and the second shaft seal portion 7. As a result, it is less possible for DME to leak out to the outside.

The case in which the inner pressure in the oil chamber 8 shown in FIG. 4 is higher than that in the mechanism compartment 50 will be described. In this case, oil flows into the mechanism chamber 50 through the clearance in the inner circumferential side of the main lip 14 and the dust lip 13 shown in FIG. 5. Thus, oil is supplied to the sliding contact portions between the main lip 14 and the rotating shaft 3 and between the dust lip 13 and the rotating shaft 3. Also, oil is accumulated in a space between the main lip 14 and the dust lip 13. The sealing and lubrication qualities of the first shaft seal portion 10 are improved by the oil.

Then, the oil flowing into the mechanism compartment 50 is recovered from the drain port 500 and flows into the fuel tank. Accordingly, it is less possible for the oil to be supplied to the main pump directly though the discharge passage 63 together with the fuel DME. Therefore, it is possible to prevent the oil density in the fuel DME from being raised suddenly and rapidly.

(Third Embodiment)

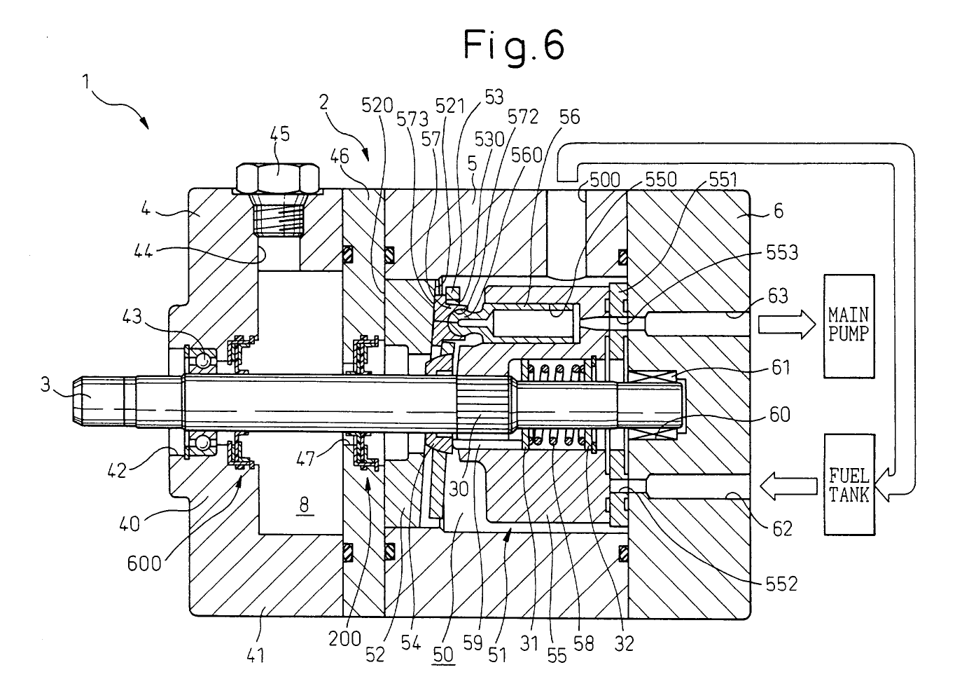

(1) The third embodiment of the shaft seal device of the present invention will be described. The construction of a pump which comprises a shaft seal device of the present embodiment is similar as the first embodiment, as shown in FIG. 6. The members, in FIG. 6, corresponding to the members in FIG. 1 are denoted with the same reference characters and numbers as in FIG. 1. The different point of the present embodiment from the first embodiment is that a first shaft seal portion 200 and a second shaft seal portion 600 of the shaft seal device is made of a lip seal. Therefore, in this description, only the different point is described.

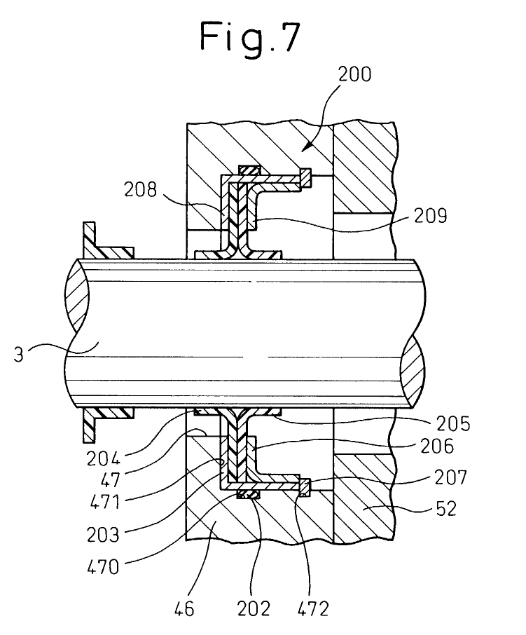

FIG. 7 shows an enlarged view of a first shaft seal portion 200 of a shaft seal device of the present embodiment. The first shaft seal portion 200 comprises an o-ring 202, an outer annular member 203, a front side resilient lip 204, a rear side resilient lip 205, an inner annular member 206, and a stopper ring 207. The outer annular member 203 is included in a torque isolating member of the present invention. The o-ring 202 which is made of a rubber is arranged in a first ring groove 470 which is provided in the through hole 47. The outer annular member 203 has a cup shape which has a hole in a bottom wall 208 and opens backward. The outer annular member 203 is pressed into the through hole 47 until the bottom wall 208 comes into contact with a step portion 471, and cannot relatively rotate. The outer annular member 203 then presses the o-ring 202 from the inner circumferential side. The inner annular member 206, similar to the outer annular member 203, has a cup shape which has a hole in a bottom wall 209 and opens backward. The inner annular member 206 has a diameter smaller than that of the outer annular member 203. The inner annular member 206 is arranged in the inner circumferential side of the outer annular member 203. The bottom wall 208 of the outer annular member 203 is spaced apart from the bottom wall 209 of the inner annular member 206, in a direction from the front to the rear. The front side resilient lip 204 and the rear side resilient lip 205 are interposed between the both bottom walls 208 and 209. The front side resilient lip 204 is made of PTFE and has a ring shape. The front side resilient lip 204 is bent forward and contacts the rotating shaft 3 so that sliding is possible. The rear side resilient lip 205, similar to the front side resilient lip 204, is made of PTFE and has a ring shape. The rear side resilient lip 204 is bent backward to the contrary of the front side resilient lip 204, and contacts the rotating shaft 3 so that sliding is possible. The stopper ring 207 is inserted into a second ring groove 472 provided in the through hole 47. The stopper ring 207 engages with the rear ends of the outer annular member 203 and the inner annular member 206 and fixes them.

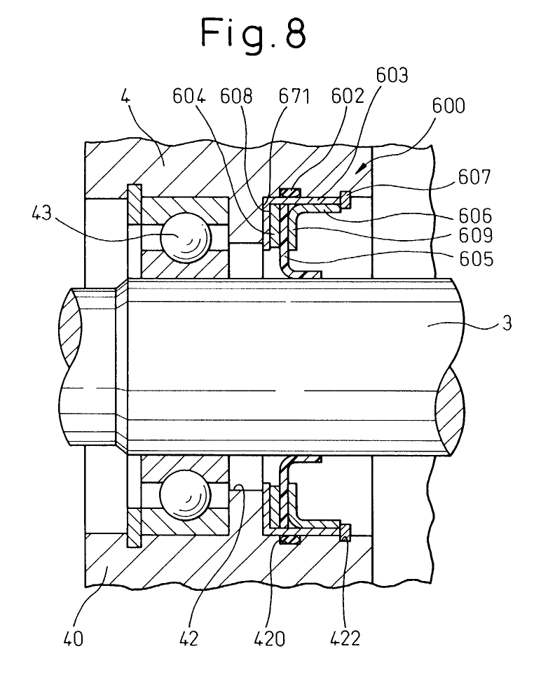

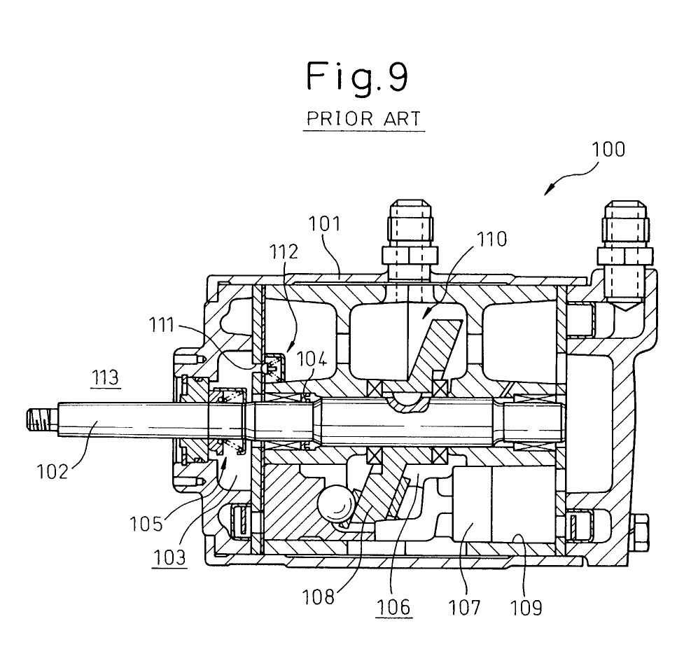

FIG. 8 shows an enlarged view of a second shaft seal portion 600 of a shaft seal device of the present embodiment. The second shaft seal portion 600 comprises an o-ring 602, an outer annular member 603, a retaining ring 604, a resilient lip 605, an inner annular member 606, and a stopper ring 607. The outer annular member 603 is included in a torque isolating member of the present invention. The o-ring 602 which is made of a rubber is arranged in a first ring groove 420 which is provided in the through hole 42. The outer annular member 603 has a cup shape which has a hole in a bottom wall 608 and opens backward. The outer annular member 603 is pressed into the through hole 42 until the bottom wall 608 comes into contact with a step portion 671, and cannot relatively rotate. The outer annular member 603 then presses the o-ring 602 from the inner circumferential side. The retaining ring 604 is arranged in the inner circumferential side of the outer annular member 603. The retaining ring 604 is adjacent to the bottom wall 608. The inner annular member 606, similar to the outer annular member 603, has a cup shape which has a hole in a bottom wall 609 and opens backward. The inner annular member 606 has a diameter smaller than that of the outer annular member 603. The inner annular member 606 is arranged in the inner circumferential side of the outer annular member 603. The retaining ring 604 is spaced apart from the bottom wall 609 of the inner annular member 606, in a direction from the front to the rear. The resilient lip 605 is interposed between the retaining ring 604 and the bottom wall 609. The resilient lip 605 is made of PTFE and has a ring shape. The resilient lip 605 is bent backward and contacts the rotating shaft 3 so that sliding is possible. The stopper ring 607 is inserted into a second ring groove 422 provided in the through hole 42. The stopper ring 607 engages with the rear ends of the outer annular member 603 and the inner annular member 606 and fixes them.

According to this construction, the first shaft seal portion 200 and the second shaft seal portion 600 are lip seals. Therefore, the seal construction thereof is simple in comparison with a mechanical seal. Moreover, it is compact in comparison with a mechanical seal.

In a shaft seal device which uses a lip seal, because a rotating side member, different from a mechanical seal, is not required to be provided on the rotating shaft 3, the rotating portion is only the rotating shaft 3 and the amount of heat, which is generated by stirring oil or DME, is small. In addition, the construction in which a lip seal is used for the second shaft seal portion has no step portion, so that the diameter of the rotating shaft 3 at the first shaft seal portion is not required to be increased. Accordingly, it is possible for the diameter of the rotating shaft 3 to be reduced, and thereby the radius of sliding movement thereof is decreased, so that it is possible to decrease heat generation.

Also, according to the present construction, the front side resilient lip 204, the rear side resilient lip 205, and the resilient lip 605 are made of PTFE, respectively. Therefore, they have high durability against the fuel DME.

The first shaft seal portion 200 in the present construction comprises the front side resilient lip 204 bent forward and the rear side resilient lip 205 bent backward. When the inner pressure in the mechanism chamber 50 is higher than that in the oil chamber 8, the rear side resilient lip 205 prevents DME from flowing into the oil chamber 8. On the contrary, when the inner pressure in the oil chamber 8 is higher than that in the mechanism chamber 50, the front side resilient lip 204 prevents oil from flowing into the mechanism chamber 50. Therefore, the present construction has a good sealing quality against the DME leakage from the mechanism chamber 50 to the oil chamber 8 and against the oil leakage from the oil chamber 8 to the mechanism chamber 50. The second shaft seal portion 600 in the present construction also comprises the resilient lip 605 bent backward. Therefore, the present construction has a good sealing quality against the oil leakage from the oil chamber 8 to the outside.

(Other embodiments)

The embodiments of the present invention have been described above. However, they should not be limited to the embodiments described above. Various variants and modifications, of the embodiments described above, which can be done by those of ordinary skill in the art can be realized. For example, in the first embodiment, the type of the mechanical seals used for the first shaft seal portion 9 and the second shaft seal portion 7 is not particularly limited. Either seal of a balance type or an unbalance type may be chosen. An inside mounting type or an outside mounting type may be chosen. Moreover, a plurality of mechanical seals may be used so as to be aligned in series.

Also, in the second embodiment, the type of the oil seal used for the first shaft seal portion 10 is not particularly limited. One, which does not have the dust lip 13, the ring spring 15, and/or the metallic ring 16, may be used. The constructions of the first shaft seal portion 9 and 10, and the second shaft seal portion 7 are also not particularly limited. An embodiment in which a gland packing or the like is used may be realized.

Also, in the third embodiment, the construction of the lip seals used for the first shaft seal portion 200 and the second shaft seal portion 600 is not particularly limited. For example, it may have a construction in which additional dust lips are provided. A sheet of a dust lip may be disposed in the first shaft seal portion 200. Two sheets of a dust lip may also be disposed in the second shaft seal portion 600. The resilient lip may be made of another fluoric resin other than PTFE. It may be made of, for example, tetrafluoroethylene perfluoroalkylvinylether copolymer (PFA), tetrafluoroethylene hexafluoropropylene copolymer (FEP), polychlorotrifluoroethylene (PCTFE), tetrafluoroethylene ethylene copolymer (ETFE), chlorotrifluoroethylene ethylene copolymer (ECTFE), polyvinylidene fluoride (PVDF), polyvinyl fluoride (PVF), or the like. Alternatively, only the surface of the resilient lip may be formed by a fluoric resin described above. The resilient lip may be formed by coating the fluoric resin on a base made of, for example, another resins or a rubber. Alternatively, the resilient lip may be made of another resins other than a fluoric resin, a rubber, or the like.

The embodiment in which the bearing 43 in the above-mentioned embodiment is arranged in the oil chamber 8 may be realized. According to the embodiment, lubricating grease for the bearing 43 can be substituted for the oil in the oil chamber 8. In the above-mentioned embodiment, the shaft seal device is installed in a swash plate pump of an axial piston type, but it may be installed in another types of pumps or fluidic machines, such as a compressor etc., other than a pump. In the above-mentioned embodiment, DME is used as the actuating fluid, but another fluids, such as propane etc., may be used.

According to the present invention, a shaft seal device, the construction of which is simple and which has an oil chamber capable of supplying oil to shaft seal portions, can be provided.

While the invention has been described by reference to specific embodiments chosen for the purposes of illustration, it should be apparent that numerous modifications could be made thereto by those skilled in the art without departing from the basic concept and scope of the invention.

1. A shaft seal device for a fluid machine, which seals a periphery of a rotating shaft of said fluid machine, comprising:
a casing within which a mechanism compartment which has a compressing or pumping mechanism portion that compresses or pumps an actuating fluid is formed; and
a rotating shaft one end of which extends outside from said casing and the other end of which is inserted into said mechanism compartment and is connected to said compressing or pumping mechanism portion;
wherein the shaft seal device comprises;
an oil chamber which is provided adjacent to said mechanism compartment in said casing, through which said rotating shaft penetrates and in which oil is hermetically filled, so that the oil chamber and the mechanism compartment are arranged side by side;
a first shaft seal portion which is arranged between said oil chamber and said mechanism compartment; and
a second shaft seal portion which is arranged between said oil chamber and an outside.

2. A shaft seal device, as set forth in claim 1, wherein the second shaft seal portion is a mechanical seal.

3. A shaft seal device, as set forth in claim 1, wherein the first shaft seal portion is a mechanical seal.

4. A shaft seal device, as set forth in claim 1, wherein at least one of the first shaft seal portion and the second shaft seal portion is a lip seal which has at least a resilient lip that contacts the rotating shaft so that sliding is possible.

5. A shaft seal device, as set forth in claim 4, wherein a surface of the resilient lip is made of a resin.

6. A shaft seal device, as set forth in claim 5, wherein the resin is a fluoric resin.

7. A shaft seal device, as set forth in claim 4;
wherein the lip seal has two sheets of the resilient lip; and
wherein said two sheets of the resilient lip are bent in different directions, in which they are separated apart each other and contact said rotating shaft so that sliding is possible.

8. A shaft seal device, as set forth in claim 4, wherein the lip seal has;
an o-ring which is arranged in an inner circumferential surface of a through hole through which the rotating shaft penetrates; and
a torque isolating member which is interposed between said o-ring and said at least a resilient lip and prevents a rotating torque of said rotating shaft from transferring to said o-ring through said at least a resilient lip.

9. A shaft seal device, as set forth in claim 1, wherein the fluidic machine is a piston type pump.
